(19) United States
(12) Patent Application Publication
(10) Pub. No.: US 2025/0162907 A1
(43) Pub. Date: May 22, 2025

(54) A DEVICE FOR REDUCING THE REDOX POTENTIAL VALUE IN COLD POTABLE WATER

(71) Applicant: WATER LAB S.R.O., Praha (CZ)

(72) Inventor: Miroslaw GLUCH, Katowice (PL)

(21) Appl. No.: 18/724,638

(22) PCT Filed: Aug. 30, 2022
(86) PCT No.: PCT/IB2022/058107

§ 371 Date: Jun. 27, 2024

(30) Foreign Application Priority Data
Dec. 27, 2021 (PL) P.439993

(51) Int. Cl. C02F 1/467; C02F 1/42; C02F 1/461; C02F 1/48

(52) U.S. Cl. CPC C02F 1/4676; C02F 1/42; C02F 1/46176; C02F 1/48; C02F 2001/46133; C02F 2001/46195; C02F 2201/4617; C02F 2209/04

(57) ABSTRACT

A device for reduction of redox potential value in cold potable water, according to the invention comprises a flow tank (1) with an inlet port (2) and an outlet port (3). The tank (1) is made 5 of chromium-nickel alloy steel, and comprises at least two cartridges (5) with bars (6) made of high-purity magnesium with the content of pure magnesium at least 99.95%, where the bars (6) extend into the inner space of the tank (1) through additional openings (7) and insulated from the tank (1). The 10 device further comprises a triggering unit (9) made up of a DC source (10) integrated with a control unit (11), where the plus pole of the triggering unit (9) is connected to the magnesium bars (6) and its minus pole is connected to the tank (1).

The invention relates to a device for reduction of redox potential value in cold potable water, which device is particularly suitable for household applications to improve quality of drinking water.

Water available in home water system is supplied from municipal networks and is suitable for consumption by humans. Quality parameters of such water include the so called redox potential that defines the water tendency to enter oxidation reactions, i.e. its ability to gain or lose electrons. Water with a positive reduction (redox) potential demonstrates oxidizing properties. The higher the positive redox potential, the more oxidizing effect of water is recorded and such water is harmful to human organisms due to presence of free radicals. On the other hand, water with negative redox potential is more beneficial for human health. The actual level of the redox potential is expressed in millivolts (mV) and measured with a Oxidation Reduction Potential (ORP) sensor, where the average redox potential for drinking water available from municipal water supply networks ranges from +180 m V to +180 mV.

The patent application PL417820A disclosed the method for reduction of the redox potential in water, where water with the redox potential from +50 m V to +250 m V is mixed with water that is exposed beforehand to glow discharges until the redox potential from −75 m V to −135 m V is reached and the ratio of admixed water may range from 0.1% to +10%. In addition, the patent application discloses the use of water subjected to glow discharges as a component for production of functionalized water or beverages.

The patent description US2004118775A1 refers to water with a reduced redox potential, where such water is produced by dissolving gaseous hydrogen that is preliminarily cooled to the temperature from −180° C. to −60° C. and supplied at the pressure from 0.5 to 500 atmospheres to water cooled to the temperature from 0° C. to 50° C. After the initial water temperature and pressure are restored it was possible to achieve water with exceptionally low redox potential of −175 mV or even less and pH quite similar to neutral pH but not more than pH=9.0. Such water with reduced redox potential is suitable for everyday use in large amounts, i.e. for drinking and cooking, with no adverse effect onto human organisms.

In turn, the patent description US5797216A discloses a device and a method for reduction of redox potential in water, where improvement of water quality covers the phases of water supply for treatment and reduction of redox potential in water by injection of atomic hydrogen into water volume.

However, none of already known devices and method enables quick, easy and efficient reduction of redox potential in drinking water supplied for household applications from municipal water supply networks.

Yet more, the patent description PL202453B discloses a device for water treatment, in particular for water disinfection, its sterilization and eradication of microorganisms. The device comprises a tank where water is fed for treatment and a group of electrodes provided inside the tank. The group of electrodes is connected to an external generator of electric pulses supplied to the mentioned group of electrodes. The generator of alternated pulses with the maximum amplitude less than 50V and with the pulse frequency ranging from 1 kHz to 5000 kHz is supplied with low voltage electric power and is provided with controls designed to automatically adjust the maximum amplitude of electric pulses, the amplitude polarization and the duty factor of the pulse waveform according to conductivity of water to be treated. The tank and the pulse generator make up a compact structure and the group of electrodes comprises at least a single electrode in the form of a wire or a bar or, alternatively, designed as an conductive coating provided on the inner side of tank walls. One embodiment of the invention assumes that the group of electrodes is made of a magnesium-containing material. But anyway, the device is designed for eradication of bacteria from water and is neither intended or suitable for reduction of redox potential in drinking water to be treated.

The aim of the present invention is to design a device intended for reduction of redox potential value in cold drinking water and suitable for operation under household conditions, with simple design and operation principle so that to enable virtually uninterrupted access to water with negative redox potential with no need of attention or any additional maintenance by users.

The invention refers to a device for reduction of redox potential value in cold potable water. Such a device comprises a flow tank with an inlet port and an outlet port. The essence of the invention consists in the fact that the tank is made of chromium and nickel steel and houses at least two cartridges with bars made of high purity magnesium with the content of pure magnesium at least 99.95%. These bars extend to the tank interior through additional openings and are electrically insulated from the tank. The device includes also a triggering unit designed as a DC power supply unit integrated with a control unit, where the plus pole of the power supply unit is connected to magnesium bars and the minus pole is connected to the tank.

The device according to the present invention can be installed under household conditions on a pipeline with cold drinking water to enable uninterrupted reduction of redox potential value for water intended for consumption by humans, where the reduction is achieved owing to a difference of electric potentials between magnesium bars and the tank.

The tank made of a material with low content of iron or a completely iron-free material contains flowing drinking water with the average temperature from 14° C. to 18.5° C. and serves as a place where hydroxyl (OH) groups are decomposed into hydrogen and oxygen, where the decomposition process is initiated by external voltage. Surplus of hydrogen does not subject to diffusion since no change of conditions takes place due to intense movements of particles and excessive hydrogen ions are absorbed by free valence orbitals of hydrogen atoms in H₂O particles. Each of two strongly polarized hydrogen atoms bounded with an oxygen atom in a water particle has four free valence orbitals and is able to absorb subsequent hydrogen atoms released from hydroxyl (OH) groups. The foregoing process enabled production of water with the redox potential value ranging from −180 mV to −260 mV. However, when the process is frequently triggered, e.g. after a dozen or several dozen of minutes by supplying an external voltage, the redox potential value as low as about −800 m V can be reached. In addition, the completed process has led to a significant, even tripled increase of magnesium ions content in drinking water, which is a desirable effect due to beneficial influence of magnesium ions onto human health when content of other metals in water, such as chromium, copper or nickel still remains low. The process is associated with an offset of water pH to a steady alkali reaction with the pH ranging from 8 to 9.9.

For the preferred embodiment of the invention the tank capacity ranges from 2 litres to 5 litres, which makes it possible to mount it inside a kitchen cupboard under a kitchen sink to achieve the most beneficial conditions for physical and chemical treatment of water. Another application of the invention assumes installation of the device in balloon-free dispensers of drinking water, which eliminates contamination of water by plastic microparticles.

Yet another preferred embodiment of the invention assumes installation of magnesium bars made of high purity magnesium with the metal content at least 99.98 since past observations confirmed the most beneficial effect of such bars for the process of the redox potential reduction.

For preferred embodiments of the invention the device has two or three magnesium bars depending on the tank volume.

In addition, the beneficial solution assumes that cartridges with magnesium bars are screwed into additional openings made in the tank and an insulating elements are inserted in between the cartridge body and each magnesium bar.

Further preferred embodiment of the invention assumes that the source of DC current is configured to operate within the voltage range from 24V to 40V, more beneficially from 30V to 40V and the most beneficially at 36V and with ranges of electric current from 350 mA to 1.5 A, beneficially from 350 mA to 950 mA, more beneficially from 500 mA to 950 mA and the most beneficially at 800 mA.

It is justified to design the control unit as a programmable clock generator with the possibility to adjust frequency of clock pulses since the frequency affects water parameters to be achieved.

The most preferred embodiment of the invention assumes that the device comprises a sensor of redox potential value mounted inside the tank. The sensor is connected to a display mounted externally to the tank and designed for instantaneous indication of redox potential value in water. However, such a solution is merely an option with no relation to the process dedicated to beneficial improvement of water parameters.

The present invention will be explained into further details in the description of one invention embodiment and by referring to the attached drawings, where:

FIG. 1 shows the tank in its longitudinal cross-section;

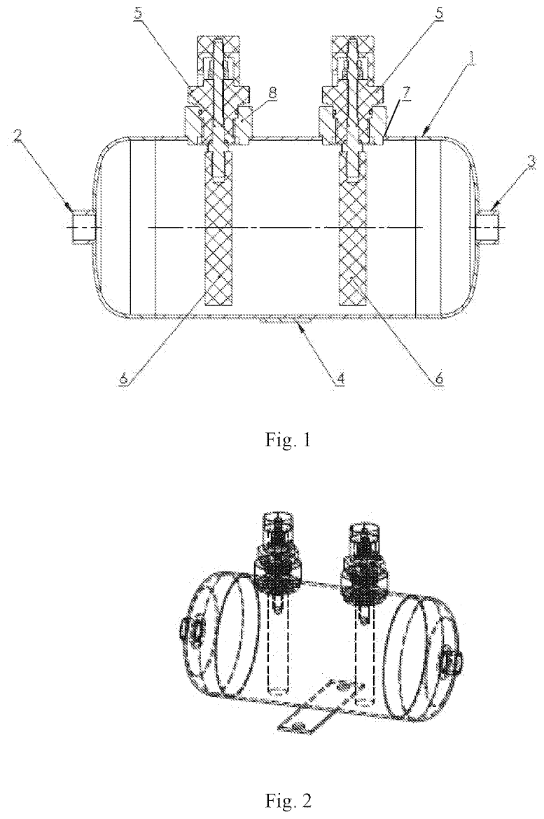

FIG. 2 shows a perspective view of the tank;

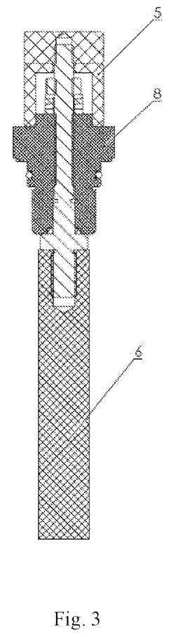

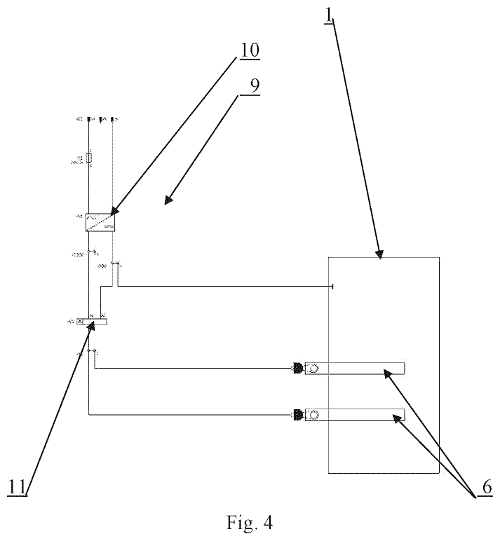

FIG. 3 shows the complete cartridge with magnesium bar in its longitudinal cross-section;

FIG. 4 shows the schematic diagram of the triggering circuit, and

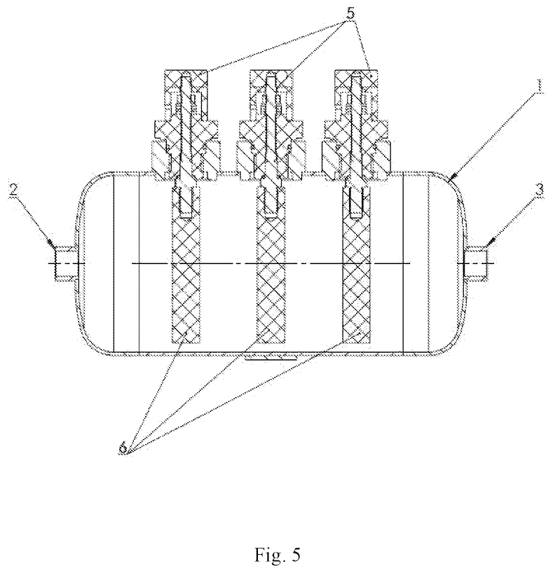

FIG. 5 shows the tank with three magnesium cartridges.

The device for reduction of redox potential value in cold potable water comprises a tank 1 with the volume from 2 to 5 litres, for instance three litres, designed for interfacing with a household water supplying system by means of an inlet port 2 and an outlet port 3. The device can be mounted e.g. inside a kitchen cupboard under a sink and fixed to a wall by means of the bracket 4. The tank 1 is made of a chromium-nickel alloy steel, in particular AISI 304, however it is possible to make the tank of an iron-free chromium-nickel alloy steel. The tank 1 is incorporated into a household water supply system and cold drinking water with the temperature from about 14° C. to 18.5° C. flows through the tank. The tank 1 comprises two cartridges 5 provided with bars 6 made of high-purity magnesium with the content of pure magnesium at least 99.95%, in particular 99.98%. Cartridges 5 extend into the inner space of tank 1 through additional openings 7 where they are screwed in and insulated from the tank 1 by means of an insulating element 8.

Another embodiment of the invention that is shown in FIG. 5 assumes that the tank 1 can be provided with three cartridges with magnesium bars.

In addition, the device comprises a triggering unit 9 designed as a low-current source 10 of DC voltage integrated with a control unit 11 designed as a programmable clock generator, where the triggering unit 9 is connected to magnesium bars 6 (see FIG. 4). The plus pole of the DC voltage source 10 is connected to bars 6 whilst the minus pole is connected to the tank 1. The DC voltage source 10 is configured to operate within the voltage range from 24V to 40V, more beneficially from 30V to 40V and the most beneficially at 36V and with ranges of electric current from 350 mA to 1.5 A, beneficially from 350 mA to 950 mA, more beneficially from 500 mA to 950 mA and the most beneficially at 800 mA.

Furthermore the device may comprise an optional sensor of redox potential value, installed inside the tank and interfaced to a display mounted externally to the tank and designed for instantaneous indication of the redox potential value in water.

The triggering unit is supplied with low voltage within the safe levels. The water treatment process may be triggered, for instance, at the voltage of 36V and current of 800 mA during the time period from about 1 minute to about 10 minutes. After triggering the process is continued in a spontaneous way due to the difference between electric potentials of the magnesium bars and the tank as well as the natural potential of H₂O dissociation. When water consumption is rather moderate and the tank 1 volume is around 5 litres, water with reduced redox potential shall be available for about 8 hours. However, when consumption of water with negative Oxidation Reduction Potential (ORP) is expected at the level above 2 litres per hour, activation of the triggering unit within adequately shorter time intervals is necessary.

The device can be also provided with well-known water filters of various types for further mechanical, chemical or biological decontamination of water but these filters are not shown on attached drawings to avoid any hindrances to understand the invention.

1. A device for reduction of redox potential value in cold potable water, comprising a flow tank (1) with an inlet port (2) and an outlet port (3), characterized in that the tank (1) is 5 made of chromium-nickel alloy steel, and comprises at least two cartridges (5) with bars (6) made of high-purity magnesium with the content of pure magnesium at least 99.95%, where the bars (6) extend into the inner space of the tank (1) through additional openings (7) and are insulated from the tank (1), and further the device comprises a triggering unit (9) made up of a DC source (10) integrated with a control unit (11), where the plus pole of the triggering unit (9) is connected to the magnesium bars (6) and its minus pole is connected to the tank (1).

2. The device according to claim 1, characterized in that the tank (1) volume ranges from 2 litres to 5 litres.

3. The device according to claim 1, characterized in that the magnesium bars (6) are made of high purity magnesium with the magnesium content at least 99.98%.

4. The device according to claim 1, characterized in that it comprises three magnesium bars (6).

5. The device according to claim 1, characterized in that the cartridges (5) with magnesium bars (6) are screwed into additional openings (7) made in the tank (1), where an insulating element (8) is inserted in between the cartridge (5) body and the magnesium bar (6).

6. The device according to claim 1, characterized in that the DC source (10) is configured for operate within the voltage range from 24V to 40V, more beneficially from 30V to 40V and the most beneficially at 36V, and with ranges of electric current from 350 mA to 1.5 A, beneficially from 350 mA to 950 mA, more beneficially from 500 mA to 950 mA and the most beneficially at 800 mA.

7. The device according to claim 1, characterized in that the control unit (11) is designed as a programmable generator of clock pulses.

8. The device according to claim 1, characterized in that it comprises an Oxidation Reduction Potential (ORP) sensor installed inside the tank and connected to a display mounted externally to the tank.
